(19) United States
(12) Patent Application Publication
(10) Pub. No.: US 2006/0263257 A1
(43) Pub. Date: Nov. 23, 2006

(54) Optical gas sensor based on dyed high surface area substrates

(76) Inventors: Jesse L. Beauchamp, LaCanada Flintridge, CA (US); Robert Hodyss, Pasadena, CA (US); Karin Oberg, Lyckeby (SE)

Correspondence Address: CHRISTIE, PARKER & HALE, LLP, PO BOX 7068, PASADENA, CA, 91109-7068, US

(21) Appl. No.: 11/302,733

(22) Filed: Dec. 13, 2005

Related U.S. Application Data
(60) Provisional application No. 60/635,796, filed on Dec. 13, 2004.

(51) Int. Cl. B32B 27/04; G01N 30/96

(52) U.S. Cl. 422/88

(57) ABSTRACT

A new optical sensing method for detection of analyte vapors down to ppb levels is described. The sensor is based on the use of a visible indicator, such as Bromocresol green, adsorbed onto a high surface area substrate, such as a silica sphere matrix. When the analyte gas is adsorb onto the matrix, the indicator undergoes a color change. The color change in turn is detected with a suitable spectrometer. Sensor performance is demonstrated for an exemplary amine sensor for the aliphatic amines tert-butylamine, diethylamine and triethylamine and also for pyridine and aniline. The microsphere sensor is more sensitive than other prior art optical amine sensor designs. The sensor response varies with temperature, with lower sensitivity and faster response at higher temperatures allowing for adjustment to prioritize sensitivity or speed. The sensor response is also highly reproducible and fully reversible.

### CROSS-REFERENCE TO RELATED APPLICATION

This application claims priority to U.S. Provisional Application No. 60/635,796, filed Dec. 13, 2004, the disclosure of which is incorporated by reference.

### STATEMENT REGARDING FEDERALLY SPONSORED RESEARCH

The invention described herein was made in the performance of work under a NASA contract, and is subject to the provisions of Public Law 96-517 (35 U.S.C. §202), in which the contractor has elected to retain title.

### FIELD OF THE INVENTION

The current invention is directed to an optical sensor for the detection of analytes; and more particularly a visible light detector for detecting visible changes on a high surface area substrate.

### BACKGROUND OF THE INVENTION

Sensing low concentrations of chemical vapors is an area of great interest with many practical applications. For example, amine vapors are of particular interest since both aliphatic and aromatic amines can induce toxicological responses at low concentrations. Further, many of these gases are relatively common, for example, aliphatic amines are found in many wastewater effluents from industry, agriculture, pharmacy, and food processing. Hence sensitive and rapid detection of gases such as amines is valuable in environmental and industrial monitoring as well as in food quality control. Simplicity, robustness, low weight and high sensitivity are attractive characteristics for chemical sensors in virtually all applications. In addition, the ideal sensor should be capable of continuously monitoring specific analyte levels free from interference with other common organic vapors.

Several different techniques have been developed for gaseous sensing. For example, conventional real-time monitoring of gases has commonly been performed employing electrochemical sensors. (See, e.g., Opdycke, W. N., et al., Anal Chim Acta 1983, 155, 11-20.) These are usually based on the oxidation of analyte gases on various anode materials or on chemically modified electrodes. (See, e.g., Surmann, P. and Peter, B. Electroanalysis 1996, 8, 685-691; Koppang, M. D., et al., Anal. Chem. 1999, 71, 1188-1195; and Casella, I. et al., E. Electroanalysis 1998, 10, 1005-1009.) In addition, biosensors have also been constructed employing immobilized materials such as, for example, amine oxidases or amine dehydrogenases. (See, e.g., Niculescu, M., et al., E. Anal. Chem. 2000, 72, 1591-1597.) Other methods of sensing include piezo crystal detectors with PVP (polyvinylpyrrolidone) coatings (Mirmohseni A. and Oladegaragoze A. Sensors and Actuators B-Chemical, 2003, 89 (1-2), 164-172), and measurements of resistance in polypyrrole films. (See, e.g., Ratcliffe, N. M. Anal. Chim. Acta, 1990, 239, 257-262.)

Unfortunately, all of these techniques have inherent disadvantages such as the need for reference electrodes, the development of surface potentials and the irreversibility of the sensor materials. To address many of these problems, researchers have attempted to employ reversible optical sensors and optical fibers to minimize electrical interference with negligible losses in remote sensing applications. Indeed, numerous amine and ammonia sensors employ optical transduction methods. For example, Charlesworth et al. described a fiber optic fluorescence based sensor for amine vapors utilizing a film of the pH-sensitive molecule 2-napthol and reported a sensitivity of about 24 ppm. (Charlesworth, J. M.; McDonald, C. A. Sens. Actuators, B 1992, 8, 137-152.) Likewise, Qin et al. designed an optical sensor for amine detection based on dimer-monomer equilibrium of indium(III) octaethylporphyrin in a polymeric film and reported a sensitivity of 0.1 ppm (detection limit of 50 ppb) for the most lipophilic of amines. (Qin, W.; Parzuchowski, P.; Zhang, W.; Meyerhoff, M. E. Anal. Chem, 2003, 75, 332-340.) Finally, McCarrick et al. constructed a visual indicator based on a calix[4]arene, bearing nitrophenylazophenol chromogenic functionalities, complexed with lithium. The modified calixarene underwent a color change from yellow to red for trimethylamine concentrations above 20 ppb. The color change results from deprotonation of an acidic chromophore. (McCarrick, M.; Harris, S. J.; Diamond, D. J. Mater. Chem. 1994, 4, 217-221.)

However, all of these devices have limited sensitivity, with a low sensitivity range of over 20 ppb, which substantially higher that that needed for most hazardous material detectors. In addition, the substrate materials used in these prior art sensors are not very robust, which makes it difficult to obtain a sensor usable over a large temperature range, and difficult to cycle for new measurements. Accordingly, a need exists for an improved gas sensor capable of providing reproducible, cost-effective, and robust analyte monitoring.

### SUMMARY OF THE INVENTION

The current invention is directed to a gas sensor based on optical monitoring of a high surface area substrate embedded with a visible analyte indicator.

In one embodiment, the gas sensor of the current invention uses a substrate formed of a plurality of micron-sized silica spheres. In such an embodiment, the spheres have a surface area of at least 100 mˆ2/g, and can be dyed with an analyte indicator capable of undergoing a visible color change in response to the presence of the analyte.

In another embodiment, the substrate is derivatized to selectively bond particular analytes.

In still another embodiment, the high surface area substrate is dyed with a pH indicator, such as, for example, bromocresol green, methyl orange or thymol blue.

In yet another embodiment, the visible indicator is detected with a fiber optic spectrometer.

In still yet another embodiment, the sensor responds optically to gas-phase sub-ppm (down to 1.4 ppb) concentrations of a gas analyte.

In still yet another embodiment, the sensor is sensitive to aliphatic amines, such as, for example, tert-butylamine, diethylamine and triethylamine and also for pyridine and aniline.

In still yet another embodiment, the sensor response is fully reversible.

In still yet another embodiment the invention is directed to an array of substrates each being disposed to indicate the presence of a separate species to allow for an multi-array detector.

### BRIEF DESCRIPTION OF THE FIGURES

These and other features and advantages of the present invention will be better understood by reference to the following detailed description when considered in conjunction with the accompanying drawings wherein:

FIG. 1 shows a schematic diagram of an exemplary optical sensor system in accordance with the current invention.

FIG. 2 shows a molecular diagram of a Bromocresol green indicator and its conjugate base according to one embodiment of the current invention;

FIG. 3 shows a series of diffuse reflectance spectrum of the LED from a white surface (A), the activated sensor (B) and the sensor exposed to 3.5 ppm tert-butylamine adsorbed onto it (C) in an exemplary embodiment of the current invention;

FIG. 4 shows absorbance spectra of an exemplary embodiment of a sensor in accordance with the current invention when exposed to 5 ppm of tert-butylamine, diethylamine and triethylamine;

FIG. 5 shows absorbance verses time spectra of an exemplary embodiment of a sensor in accordance with the current invention at different temperatures when exposed to 1.4 ppm tert-butylamine;

FIG. 6 show absorbance curves from an exemplary embodiment of a sensor in accordance with the current invention when exposed to concentrations of between 0.14 and 28 ppm of tert-butyl amine;

FIG. 7 shows spectra from successive sensor responses at 620 nm for triethylamine at the concentrations 0.11, 0.22, 0.32, 0.43 and 0.54 ppm, respectively using an exemplary sensor in accordance with the current invention;

FIG. 8 presents a graphical representation of the relationship between absorbance and concentration of tert-butyl amine, diethylamine and triethylamine from data taken using an exemplary sensor in accordance with the current invention;

FIG. 9 shows absorbance spectra at 620 nm verses time for a pair of 1.4 ppm tert-butyl measurements using an exemplary sensor in accordance with the current invention; and

FIG. 10 shows an absorbance spectrum for 1.4 ppb tert-butylamine, taken with an exemplary embodiment of a sensor in accordance with the current invention.

### DETAILED DESCRIPTION OF THE INVENTION

The current invention is directed to a new optical sensing method for sensitive detection of analyte vapors down to ppb levels. The sensor is based on the detection of changes in a visible indicator adsorbed onto the surface of a colorless high surface area substrate.

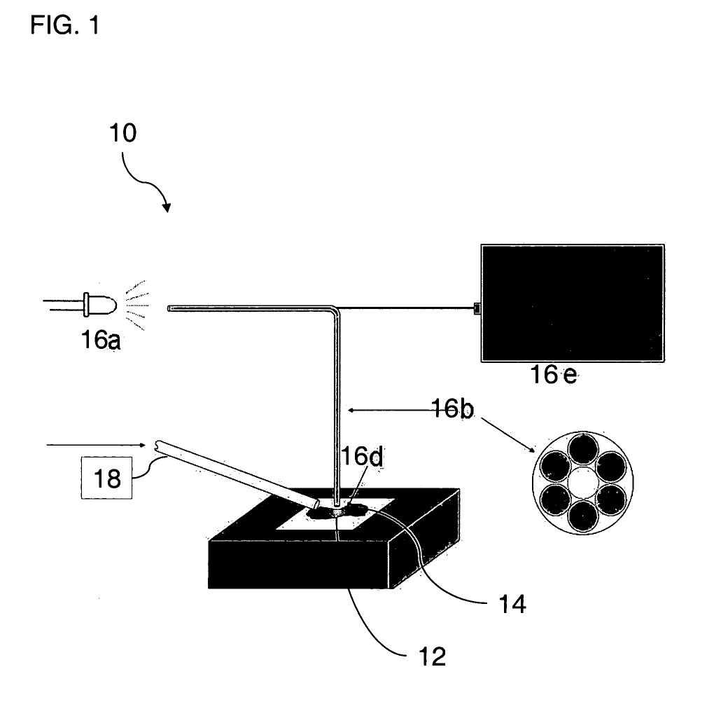

One exemplary embodiment of the invention is shown schematically in FIG. 1. As shown, the gas sensor (10) of the current invention generally comprises a high surface area substrate (12) that has been modified with a visible indicator (14) that can be interrogated with a visible detector (16). In the exemplary embodiment shown in FIG. 1, the sensor (10) is based on the pH indicator Bromocresol green, which is adsorbed onto a silica sphere matrix (12). The bromocresol green indicator undergoes a color change from orange to blue when a basic materials is absorbed onto the high surface area matrix, and a fiber optic spectrometer (16) is provided to detect the color change. In this embodiment, an optical fiber (16b) carries both incoming light from the LED source (16a) and the reflected light from the sensor (16d) to the spectrometer (16e). The tube (18) is optional and is provided merely to direct a controlled pulse of an analyte gas onto the detector for testing purposes.

Although a specific embodiment of the gas sensor of the current invention is described above, it should be understood that many alternative arrangements can be provided.

For example, although in the above-description a silica microsphere substrate is used, it should be understood that any suitable high surface area substrate capable of adsorbing an analyte indicator and providing an inert base upon which the visible change of the indicator can be observed may be utilized. For example, suitable substrates may include other high surface area materials, that is materials having a surface area of about 100 mˆ2/g or higher, such as cellulose, or other forms of silica such as silica wafers or aerogels (which can have surface areas of 3000 mˆ2/g). Although these other substrate materials are contemplated by the current invention, silica microspheres are a preferred substrate material because of the ease with which the silica sphere matrices are prepared and modified. Silica spheres are also easily derivatized, and due to the mild reaction conditions it is possible to incorporate various molecules, dyes, organic and organometallic reagents into the silica matrix. In addition, derivatization of the silica would enable the creation of sensors that are more selective with regard to the analyte species for detection. Silica sphere matrices are also chemically and mechanically stable and the average pore size, pore size distribution, surface area, refractive index, and polarity of the resultant matrix can be controlled and tailored. (See, e.g., Collinson, M. M. Critical Reviews in Analytical Chemistry, 1999, 29(4):289-311, the disclosure of which is incorporated herein by reference.) Finally, silica has a very high surface area, for example, silica spheres have a surface area of about 350 mˆ2/g and silica gels can range from about 100 mˆ2/g to about 600 mˆ2/g. Such high surface areas are important in improving the sensitivity of the detector as the higher surface area allows for the interaction of greater proportion of the analyte. These properties have enabled the construction of a number of selective chemical sensors. (See, e.g., Collinson, M. M. Critical Reviews in Analytical Chemistry, 1999, 29(4):289-311; von Bultzingslowen, C. et al Analyst, 127 (11) 2002 1478-1483; Makote R, Collinson M. M. Anal. Chim. Acta 394 (2-3): 195-200 Aug. 9 1999; and Onida, B., et al., Phys. Chem. B, 2004, 108:16617-16620, the disclosures of which are incorporated herein by reference.)

Likewise, although a basic pH indicator (bromocresol green) is proposed as the visible indicator in the above-referenced exemplary embodiment, it should be understood that any suitable visible indicator may be utilized in the current invention. For example, there are a wide-range of pH indicators across the spectrum of pH values that may be substituted for bromocresol green, including, for example, methyl orange (which changes from red to yellow over pH 3.2-4.4) and thymol blue (which changes red to yellow over 1.2-2.8). Beyond substitute pH indicators, it should also be understood that visible indicators sensitive to other analytes might also be used, such as, for example, organic indicators that detect for a particular functional group, such as, for example common stains for TLC plates, including ninhydrin (which reacts with amines to produce a blue color), potassium permangenate (KMnO4) (in this case exposure to vapors with a site of unsaturation would lead to a yellowish color), and p-anisaldehyde (which reacts with a variety of compounds producing a variety of different colors).

Further, although a fiber optic spectrometer is identified in the above-referenced exemplary embodiment, it should be understood that any suitable visible light spectrometer capable of detecting the color change of the indicator may be used with the current invention. In addition, other detection schemes not including spectrometers could also be used, including, for example monitoring by the user directly, or a color detecting video system. Moreover, although the detection scheme shown in the embodiment of FIG. 1 shows only a simple spectrometer, it should be understood that such a spectrometer could be incorporated into a larger analyzer system capable of comparing the signal from said spectrometer to a standard to determine the identity of an unknown, or the concentration of the detected analyte in the atmosphere. Such analysis techniques will be described more thoroughly with regard to the Examples provided below.

Finally, although only single species detectors are described above, it should also be understood that an array of chemical sensors, each with a different indicator or derivatization, could be used to determine either both the concentration and identity of a gas species, or the identity of multiple gas species in a sample. In addition, it should be understood that a number of peripheral system, not shown in the Figures might also be incorporated into the sensor of the current invention. For example, the sensor could include a temperature controller for controlling the temperature at which said indicator is operating. Likewise, the body of the sensor might take any suitable form, including any enclosure or gas circulation system for improving the efficiency of the detector or its operability in harsh environments.

### EXAMPLE

### Amine Sensor

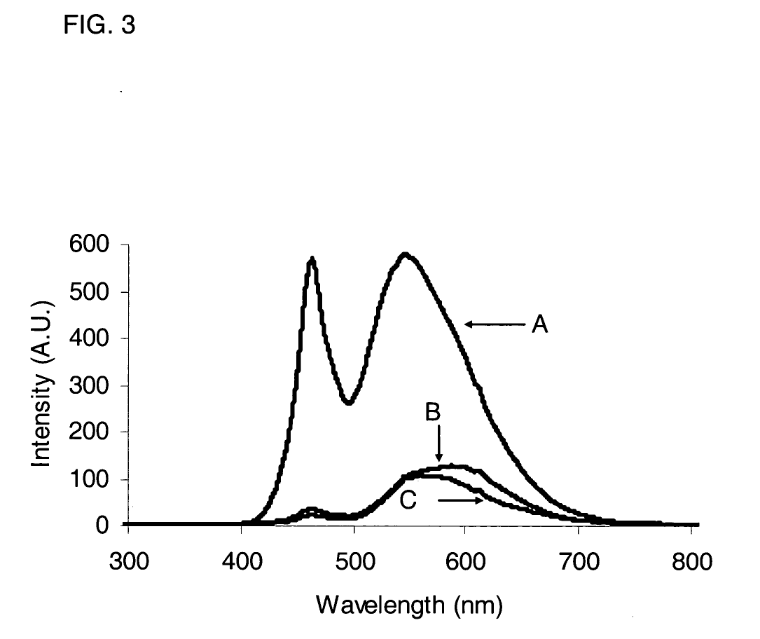

To demonstrate the performance of an exemplary gas sensor in accordance with the current invention, a sensor system capable of detecting amines was constructed. FIGS. 3 to 10 provide the results of a series of experiments conducted to demonstrate the sensitivity of the device to aliphatic amines, such as tert-butylamine, diethylamine and triethylamine and also for pyridine and aniline. In addition to merely detecting the presence of amines, it is also shown that sensor response varies with temperature, with lower sensitivity and faster response at higher temperatures allowing for adjustment to prioritize sensitivity or speed. And finally, that the sensor response can be made to depend on the concentration of analyte vapor. Sensor response is also shown to be highly reproducible and fully reversible allowing for the repeated use of the sensor.

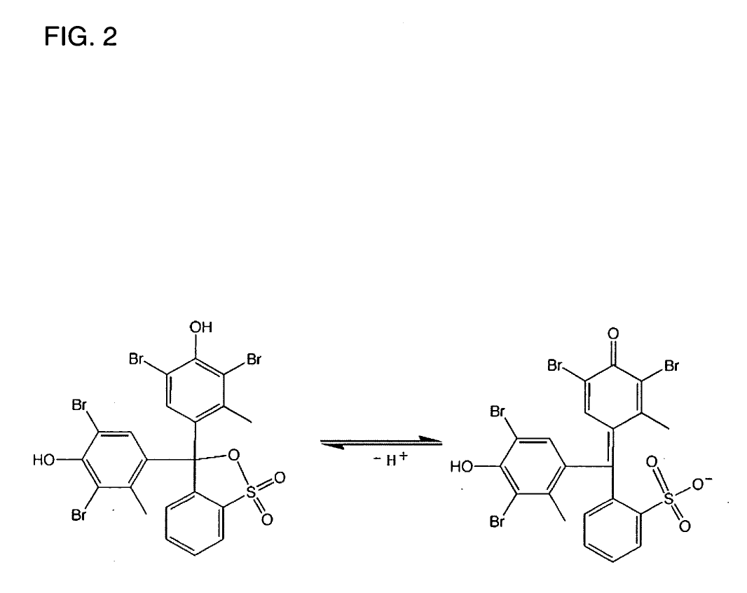

The amine sensor in the exemplary embodiment used for the current invention comprised a thin multilayer of silica spheres with an adsorbed indicator dye. A uniform suspension was obtained by sonicating a mixture of 60 mg silica spheres (silica microspheres (5 μm diameter) were obtained from Alfa Aesar), 24 mg bromocresol green (pH indicator dye Bromocresol green was purchased from Sigma, a molecular diagram of the indicator is provided in FIG. 2) and 400 μL acetone for 2 min. Glass plates were cleaned in piranha solution (3:1 conc. H₂SO₄:30% H₂O₂) and stored in methanol until used. A couple of drops of silica suspension (total volume 10 μL) were manually applied to a clean glass plate kept tilted at an angle of ˜11°. This created a thin, locally uniform layer of silica spheres (1 to 3 layers of spheres deep), as the drop spread and dried. The sensor was allowed to dry overnight in a desiccator. The sensing films thus produced are a deep orange color, which changes to blue when exposed to amine vapors. (All amines used in the following experiments were analytical or reagent grade products and used without further purification. Triethylamine, tert-butylamine and aniline were obtained from Aldrich, diethylamine from Sigma and pyridine from EM Science.)

This exemplary sensor is based on the spectral properties of pH indicator bromocresol green. Like most pH indicators, bromocresol green (tetrabromo-m-cresolsulfonphthalein) is a weak organic acid whose absorbance spectrum is quite different from the absorbance spectrum of its conjugate base. The structure of bromocresol green and its conjugate base are shown in FIG. 2. A bromocresol green solution changes from yellow to blue over the pH range 3.8-5.4, as the equilibrium shifts to the deprotonated, arylmethine form of the dye. (See, e.g., Wang, E. and Zhisheng, S. Anal. Chem. 1987, 59, 1414-1417, the disclosure of which is incorporated herein by reference.) Bromocresol green was selected as the pH indicator because of its appropriate endpoint and the high uptake by the silica beads, probably due to its many polar groups.

During the experiments, nitrogen was used as the carrier gas for all experiments. Amine vapor samples were prepared in Tedlar bags at concentrations between 500 ppm and 70 ppb. The amine vapor was diluted with a gas diluter (Custom Sensor Solutions, Model 1010 Precision Gas Diluter) before entering the system through a glass tube (FIG. 1, (18)). The flow rate of diluted amine vapor through the glass tube was 1300 mL/min. This is high enough to saturate the space around the sensor with diluted amine vapor at the desired concentration, and so the sensor is not enclosed in a chamber. The amine sensor (approximately 5×10 mm) was mounted on a temperature controlled aluminum block. A white LED detector (FIG. 1, (16)) was employed as the light source. The output of the LED was passed into the excitation bundle of a six-around-one fiber optic probe (FIG. 1, (16b)). The inset of FIG. 1 shows a view of the end of the fiber optic probe (16b) facing the sample. Six illumination fibers surround a single read fiber. The diameter of each individual optical fiber was 0.5 mm. The end of the probe was held a few millimeters above the amine sensor. During operation, reflected light is collected by the read fiber of the probe and is analyzed with a fiber optic spectrometer (FIG. 1, (16e)) (Ocean Optics S-2000 fiber optic spectrometer). The absorbance of the light by the sensor over time was analyzed as described below using software supplied by Ocean Optics Inc.

Each new amine sensor was activated by flushing with 7 ppm tert-butylamine before use to produce reproducible results and maximum sensitivity. The response to the amine vapor diminishes after heating for approximately 20 min at 80° C. in the absence of amine vapor. The sensor can be activated again with tert-butylamine to restore sensitivity.

The reported absorbance in FIGS. 3 to 10 is the change in light absorption between the activated sensor and the sensor with analyte amines adsorbed onto it, where absorbance is defined as A=−log (I/Iₒ). Conventionally, light absorbance of a substance is compared to absorbance of a white surface, i.e. Iₒ is the intensity of the light reflected off a white surface. In this sensor system it is more convenient to employ the clean sensor as the absorbance reference, Iₒ. The main advantage is that the difference in the intensity of reflected light between the sensor with and without amine is much smaller than the intensity difference between the sensor and the white background. FIG. 3 gives the raw diffuse reflectance spectra from the exemplary gas sensor according to the current invention. Curve A shows the reflectance spectra of the LED source from a white surface. Curve B and C show the reflectance from the activated sensor and the sensor with absorbed amine, respectively. FIG. 3 also shows that the maximum intensity difference with and without amine adsorbed onto the sensor occurs around 620 nm. Hence all absorbance data was acquired at 620 nm, except for spectra covering the whole wavelength region, with curve B used as the absorbance reference, Iₒ.

To determine the effect of temperature variations, the sensor system was tested with 1.4 ppm of various amines for 2 min at temperatures between 20° C. and 120° C. All other experiments were performed at the optimal temperature of 80° C. The sensitivity was examined for tert-butylamine, diethylamine and triethylamine with concentrations ranging between 0.1 and 2 ppm for diethyl and triethylamine and 1.4 ppb to 28 ppm for tert-butylamine. The aromatic amines pyridine and aniline were only briefly examined at much higher concentrations (approximately 40 and 200 ppm).

For each series, the sensor was exposed to amine vapor for 2 min at each concentration. After the amine vapor was turned off, the sensor was flushed with pure nitrogen until at least 95% of the original signal was recovered.

Experiment 1: Species Sensitivity

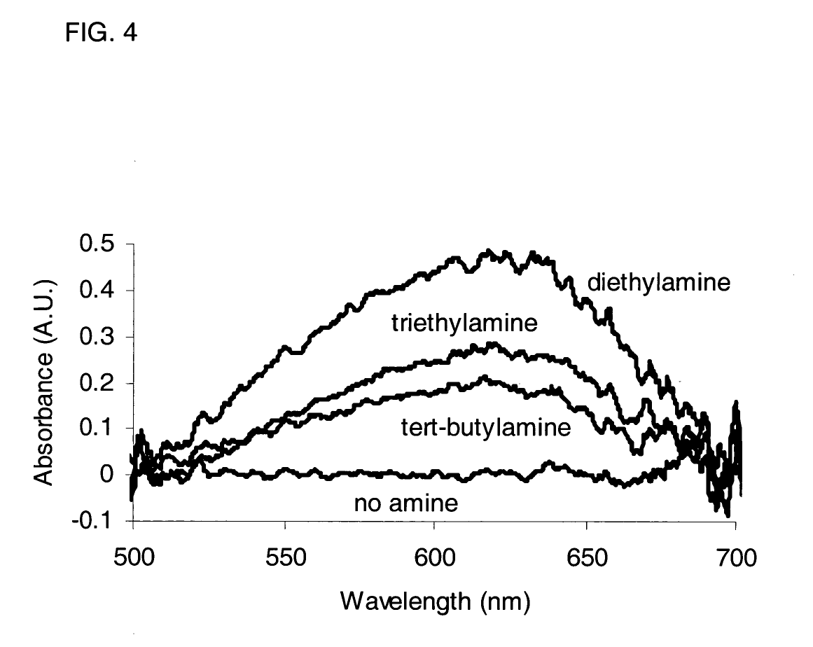

FIG. 4 shows the response of the sensor to 5 ppm diethylamine, triethylamine and tert-butylamine. By using the sensor itself as a reference, the baseline is set to zero and the absorbance peaks are clearly defined. The maximum absorbance is located at 620 nm for all amines. Thus the absorbance at 620 nm was monitored to evaluate the response of the sensor to temperature and concentration, as well as saturation and recovery times. FIG. 4 also demonstrates a sensitivity difference between diethylamine, triethylamine and tert-butylamine. The response varies significantly between the amines and the difference is correlated to the amines k_{B} not their acidity in the gas phase. In addition to these aliphatic amines, the sensor was also tested with aniline and pyridine, with the resulting relative sensitivity: diethylamine>triethylamine□tert-butylamine>>aniline>pyridine.

Although not to be bound by theory, the response appears to depend ultimately on two factors, the basicity and the hydrogen bonding capability in relation to adsorption of the amine on the silica surface. In solution the dialkyl amines have the highest pKₐ while in the gas phase the trialkyl amines are the most basic. The tendency of alkyl groups to stabilize charge through a polarization mechanism accounts for the basicity of triethylamine in the gas phase. The combined effects of polarization and solvent stabilization due to hydrogen bonding result in a leveling of amine basicities in solution compared to the gas phase. (For a more thorough exploration of this subject, see, e.g., Arnett, E. M., et al., J. Am. Chem. Soc. 1972, 94, 4724-4726, the disclosure of which is incorporated herein by reference.) For example, solvent stabilization by hydrogen bonding results in dialkylamines being slightly more basic than trialkylamines. The response pattern, from the relative absorbance strength diethylamine>triethylamine>tert-butylamine, suggests an environment where hydrogen bonding is important, similar to that of a solution. It is likely that the amines are hydrogen bonded to hydroxyl groups on the silica surface, which corroborates studies suggesting that interaction of adsorbates with the hydroxyl sites on the silica surface generally accounts for the major part of adsorption. The response for pyridine and aniline was orders of magnitude smaller than for the aliphatic amines. The detection limit for aniline is approximately 200 ppm while no response was detected for 230 ppm pyridine. This can be explained by the lower basicity of these compounds, see Table 1, below.

TABLE 1
Amine Properties

| Amine | pKₐ | Gas Basicity (kJ/mol) |
|---|---|---|
| Diethylamine | 10.84 | 919.4 |
| Triethylamine | 10.75 | 951.0 |
| Tert-butylamine | 10.68 | 899.9 |
| Aniline | 5.23 | 850.6 |
| Pyridine | 4.58 | 898.1 |

pKₐ values from: Handbook of Chemistry and Physica, 82nd edition, CRC Press LLC, 2001.
Gas basicity values from: Hunter, E. P. and Lias, S. G. J. Phys. Chem. Ref. Data, 1998, 27, 413-656.

The correlation between basicity and response indicates that response is mainly determined by basicity of the amine. There is also a difference in adsorption of the amines, however. The strength of the hydrogen-bond interaction between a silica surface and an amine can be measured spectroscopically. Van Cauvelaert measured a significantly stronger interaction between silica and triethylamine compared to butylamine. (See, e.g., Van Cauwelaert, F. H., et al., Discussions of the Faraday Society, 1976, 52: 66-76, the disclosure of which is incorporated herein by reference.) They concluded that the strength of the interaction depended both on the acid-base properties of the molecule and the steric effects between large groups and the silica surface. This indicates that the selectivity of the gas sensor of the current invention can be enhanced by employing a derivatized silica surface, which could select for not only the acid-base properties of the amine, but the shape of the molecule as well. For example, by substituting the hydroxyl end groups on the silica microspheres with alkanes or acids, the substrate could be conditioned to selectively bond specific gas analytes. In addition, by calibrating the sensor prior to detection, the differential response shown to different amine molecules could allow for the identification of not just the presence of an amine, but the identity of the detected amine as well.

Experiment 2: Temperature Dependence

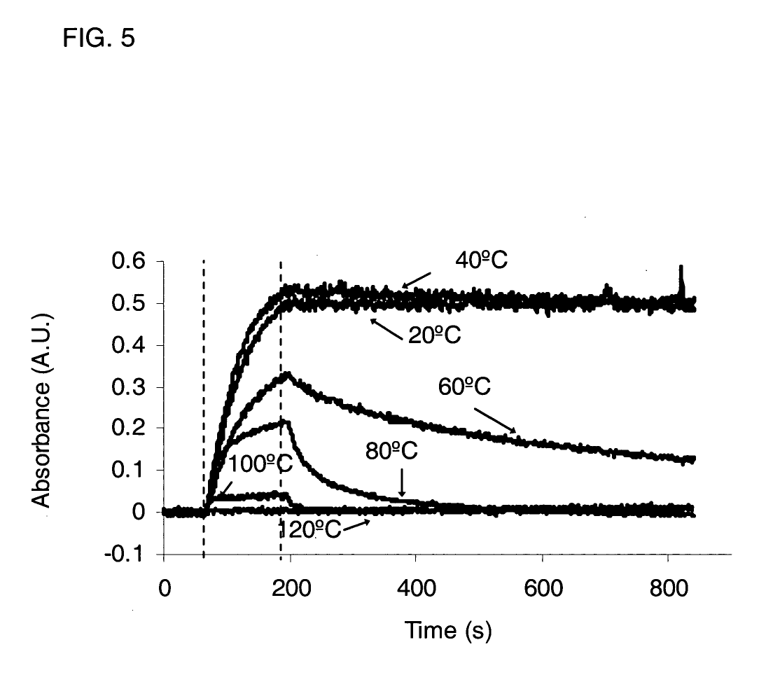

The effect of temperature on the operation of the sensor system was investigated by comparing sensitivity and detection time at 620 nm for 1.4 ppm tert-butylamine vapor at temperatures between 20° C. and 120° C., and the results of these tests are provided in FIG. 5. For each temperature, the amine vapor was flowed over the sensor for 2 min followed by 10 min of recovery time. Sensitivity, response time and recovery time are all dependent on temperature. At temperatures below 60° C. the evaporation of amine within 10 min is insignificant and the sensor is very sensitive but effectively irreversible. At 60° C. and higher, the sensitivity and recovery time each decreases with temperature. At 120° C. there is no longer any response for an amine vapor concentration of 1.4 ppm and hence no higher temperature was investigated. For all experiments described in the next section, 80° C. was employed as the operational temperature as a compromise between a reasonable recovery time of ˜10 min and loss of sensitivity at higher temperatures. This experiment provides for the possibility that the sensitivity and response characteristics of the sensor could be tuned by providing a temperature variable control stage upon which the sensor rests. For example, using such a temperature control stage would allow for variable minimum detection limits to be set, allowing for the selective control of the indicator.

Experiment 3: Concentration Dependence

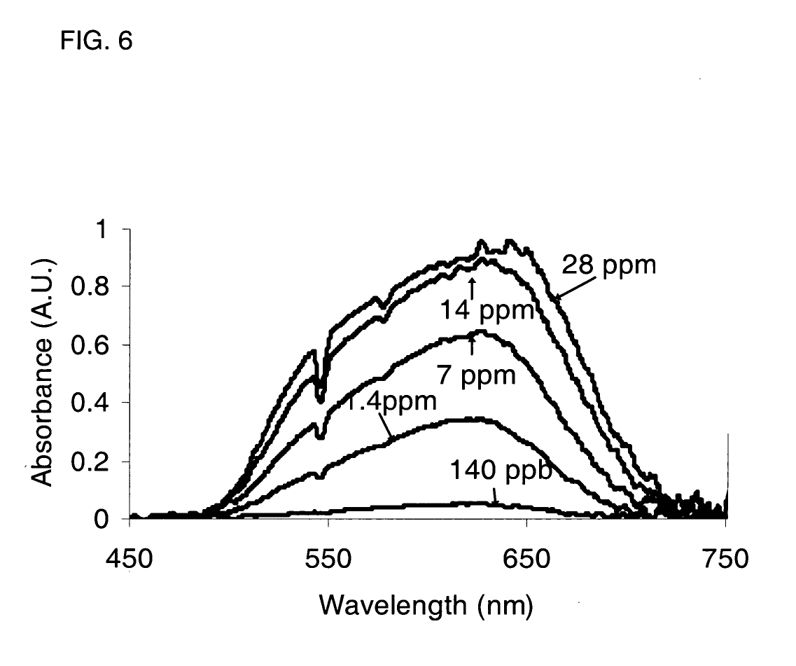

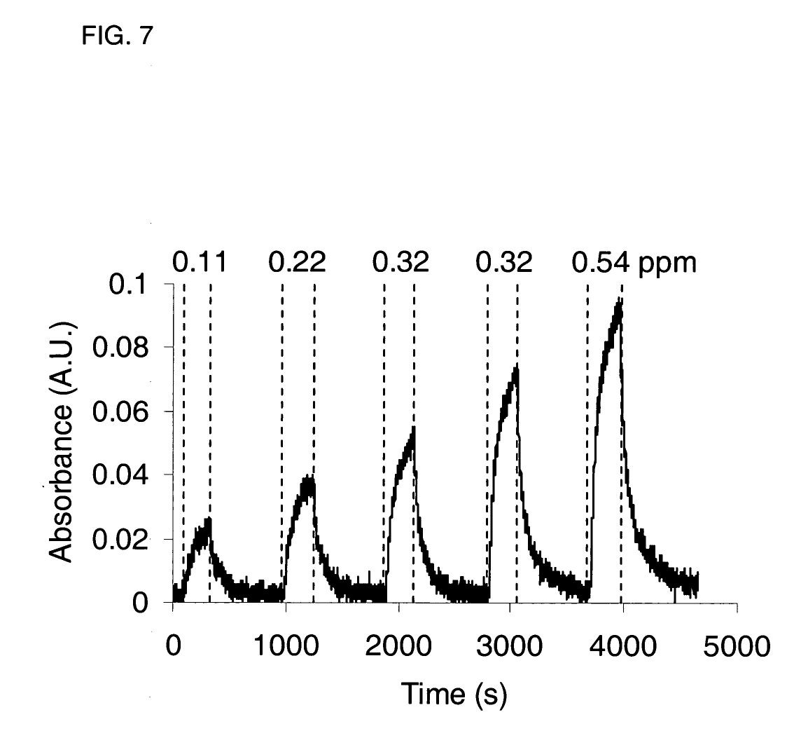

FIGS. 6 to 8 all show the results of experiments to determine the ability of the sensor to determine the concentration of the gas analyte. In a first experiment, summarized in FIG. 6, Tert-butylamine was detected with a range of concentrations from 140 ppb to 28 ppm. At 28 ppm the system appears close to saturation and no higher concentrations were tested for the aliphatic amines. The signal strength is clearly dependent on the amine concentration. The maximum absorbance is essentially constant at 620 nm, however, and hence for all other measurements only the peak intensity at 620 nm as a function of time was recorded. Supplementary data was acquired for tert-butylamine in the low concentration region of 0.11 to 0.54 ppm. Similar data were recorded for triethylamine and diethylamine. FIG. 7 shows the sensor response at 620 nm for triethylamine at 2 min amine exposures between 0.11 and 0.54 ppm.

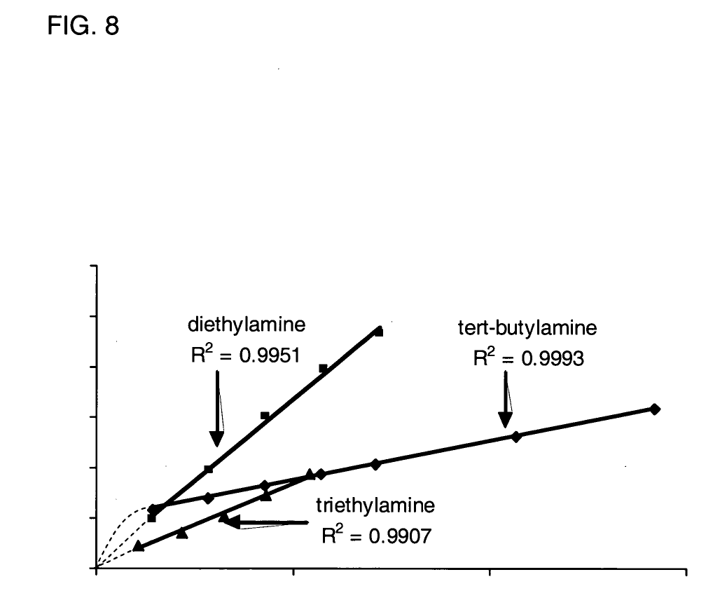

A least square regression was employed to model the detector response as a function of concentration for each amine at concentrations between approximately 0.1 and 1 ppm. FIG. 8 shows the response of the sensor after two minutes of amine exposure to different concentrations of tert-butylamine, diethylamine and triethylamine. Linear regression fits the sensor response at low concentrations very well, with a regression constant larger than 0.99 for all three amines. The sensitivity function of the sensor differs between the amines. One novel feature of this graph is the non-zero intercept for the tert-butylamine fit. The trend lines for triethylamine and diethyl amine pass through the origin, but the tert-butylamine trend line exhibits a non-zero intercept. Activating the sensor with triethylamine yielded the same curve for tert-butylamine as activating with tert-butylamine. To examine if the non-zero intercept was a general feature for primary amines the behavior of ethylenediamine was investigated. The result was a very similar curve to tert-butylamine with a non-zero y-axis intercept. The observed intercept suggests that at the concentrations used here for tert-butylamine, the analyte has begun to saturate the sensor, and enter a second region of linear response, leading to a flatter curve with a non-zero intercept. This leads to a steep slope for the tert-butylamine curve at concentrations below 0.14 ppm (the lowest concentration shown on the graph). Extrapolated curves that intersect the origin and illustrate this possibility are shown in FIG. 8 as dashed lines. The slopes at these low concentrations would be ordered tert-butylamine>diethylamine>triethylamine.

Although not to be bound by theory, the reason for the concentration dependence and the faster saturation of binding sites for primary amines than for secondary and tertiary amines, and the relative steepness of the slopes most likely comes from the indicator. The bromocresol green very likely interacts with the silica surface by hydrogen bonding involving the OH and SO₃ functional groups on the molecule. The color change is associated with the deprotonation of the dye by the adsorbed amines and presumably the conjugate acid of the amine interacts both with the surface hydroxyls and the dye molecules by strong hydrogen bonding. The nature of the surface hydroxyls is a key factor to consider. For example, Hertl defined two types of hydroxyls possible on the surface. A-type hydroxyls do not participate in hydrogen bonding interactions, and are “free.” B-type hydroxyls are those that are participating in a hydrogen bond. (See, e.g., Hertl, W.; Hair, M. L.; Journal of Physical Chemistry 1968, 72, 4676-4683, the disclosure of which is incorporated herein by reference.) It has been suggested that primary amines have an extended interaction with B-type hydroxyls (hydrogen bonded hydroxyls) on the silica surface compared to secondary and tertiary amines, which interact more with A-type hydroxyls (free hydroxyls). If there are fewer B-type hydroxyls available, primary amines would saturate faster. This would lead to the non-zero intercept described above. The ordering of the slopes implies that primary amines adsorb and react with the dye at a faster rate than secondary amines, which are faster than tertiary amines. Accordingly, these results indicate that not only can an appropriately calibrate gas sensor in accordance with the current invention determine the concentration of an analyte gas, but also that the identity of that gas can also be determined based on the concentration slope.

Experiment 4: Reproducibility/Recovery Tim

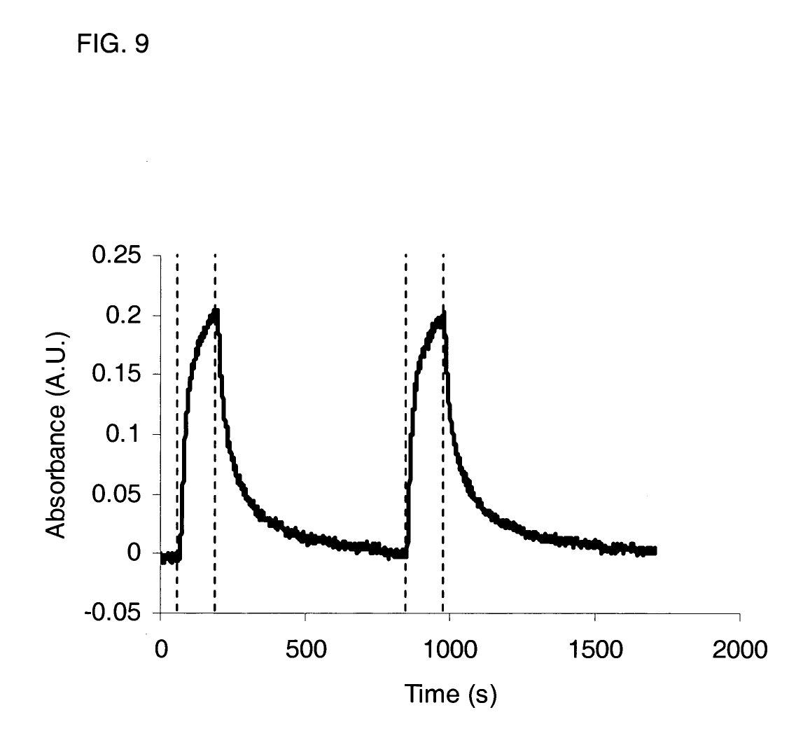

FIG. 9 demonstrates the reproducibility of the exemplary gas sensor exposed to 2 min of 1.4 ppm tert-butylamine twice with 12 min in between each exposure. The difference in absorbance for detection 1 and 2 is well within the error of the gas diluter, which is 15% at these concentrations (from the model specifications). The variation between the two measurements is here 1% of the maximum absorbance. The recovery time was defined as the time from turn-off of amine vapor to the time when the signal has decreased 95%. The recovery time is a function of concentration, with a value of 8 min for 1.4 ppm tert-butylamine. This is typical for ppm concentrations. Measurements on sub-ppm concentrations typically had a recovery time of less than 5 min and 3 min for ppb level concentrations. Accordingly, this demonstrates the inventive sensors ability to reproducibly and repeatedly detect an analyte gas.

Experiment 5: Detection Limit

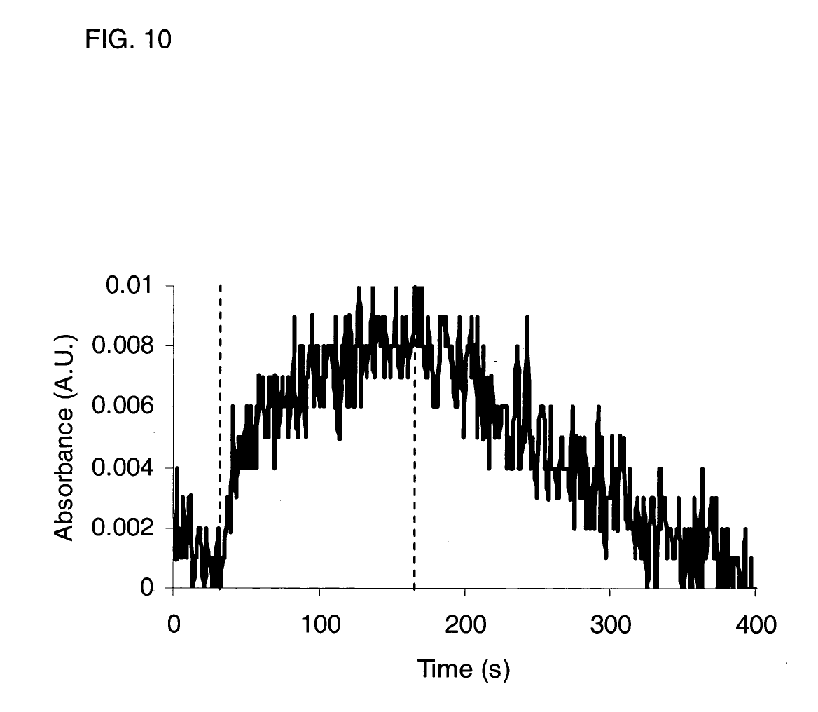

FIG. 10 summarizes the results of experiments taken to determine the low limit of detection for a sensor in accordance with the current invention. At 1.4 ppb tert-butylamine vapor the absorbance was approximately 5 times the noise level and 1 ppb is hence the detection limit for the exemplary gas sensor in accordance with the current invention.

Experiment 6: Interference Effects

Analytes other than the analyte in question could theoretically interfere with the sensor. Water, due its presence in most settings, is one of the most likely molecules that could present interference. Although not shown in an accompanying graphs, flushing the sensor with water vapor in ppm concentrations had little effect on the sensor response. In addition comparable gas concentrations of methanol, acetone, ether and dichloromethane had no visible effect on the sensor. From these investigations, it is clear that the only compounds that would interfere with the amine measurements would then be substances more basic than the adsorbed dye. Very few molecules have comparable basicities and interference, and hence should not be a problem in common settings.

A new optical sensing method for detecting low-concentration amine vapors down to ppb levels has been described. The sensor is based on the spectral properties of an analyte indicating substance, such as the pH indicator Bromocresol green, adsorbed onto a high surface area substrate, such as a silica sphere matrix. As shown in the results of tests taken on an exemplary embodiment of the sensor, the current invention can easily detect sub ppm concentrations of analytes, such as common aliphatic amines and has a linear response up to 2 ppm. The detection limit is below 1.4 ppb, which makes this sensor more sensitive than comparable prior art optical sensors. The response varies with temperature, allowing for adjustment to prioritize sensitivity or speed, and the responses for each sensor were reproducible and fully reversible.

Although specific embodiments are disclosed herein, it is expected that persons skilled in the art can and will design alternative visible gas sensors and methods to produce such gas sensors that are within the scope of the following claims either literally or under the Doctrine of Equivalents.

Specifically, there are many different visible analyte indicators form a variety of different chemical fields. Examples include acid-base chemistry, oxidation/reduction chemistry, and functional group chemistry. There also exist a large number of high surface area substrates that might be suitable to dye with such indicators. Thus a number of possibilities will arise for one skilled in the art for using a variety of high surface area materials as a substrate on which to place such visible indicators, and hence to use as visible indicators for a wide variety of applications.

What is claimed is:

1. A gas sensor for detecting an analyte comprising:
a color neutral material having a surface area of at least 100 mˆ2/g;
an indicator material disposed on said high surface area material capable of undergoing a reversible visible color change when exposed to said analyte; and
a detector in line of sight with said high surface area material for detecting said color change.

2. The gas sensor as in claim 1, wherein said high surface area material is selected from the group consisting of silica microspheres, an aerogel, or cellulose.

3. The gas sensor as in claim 1, wherein the high surface area material is a plurality of silica microspheres disposed on a substrate.

4. The gas sensor as in claim 1, wherein the indicator material is selected from the group consisting of a pH indicator and an functional group indicator.

5. The gas sensor as in claim 1, wherein the indicator material is a pH indicator selected from the group consisting of bromocresol green, thymol blue and methyl orange.

6. The gas sensor as in claim 1, wherein the detector comprises:
at least one led filament for illuminating the high surface area material;
at least one fiberoptic filament for capturing the reflected light from said high surface area filament; and
a spectrometer for measuring the reflected light from said fiberoptic filament.

7. The gas sensor as in claim 5, wherein the pH indicator is bromocresol green and the analyte is an amine.

8. The gas sensor as in claim 7 wherein the amine is an aliphatic amine.

9. The gas sensor as in claim 1, further comprising:
a stored calibration standard; and
an analyzer for comparing a signal from said detector with said calibration standard to determine at least one of the identity or concentration of said analyte.

10. The gas sensor of claim 1, wherein the sensitivity limit of said sensor is about 1.0 ppb.

11. The gas sensor of claim 1, further comprising a temperature controller; and
wherein said high surface area material is positioned in proximity to said temperature controller such that the temperature of said high surface area material is controlled by said temperature controller.

12. The gas sensor of claim 1, further comprising an array of a plurality of said high surface area materials.

13. The gas sensor of claim 12, wherein said array has disposed thereon at least two different indicator materials.

14. A gas sensor for detecting amines comprising:
a plurality of high surface area silica microspheres;
a bromocresol green indicator material disposed on said silica microspheres capable of undergoing a reversible visible color change when exposed to said amines; and
a detector in line of sight with said silica microspheres for detecting said color change.

15. The gas sensor of claim 14, further comprising:
a stored calibration standard; and
an analyzer for comparing a signal from said detector with said calibration standard to determine at least one of the identity or concentration of said amines.

16. The gas sensor of claim 14, further comprising a temperature controller; and
wherein said silica microspheres are positioned in proximity to said temperature controller such that the temperature of said silica microspheres is controlled by said temperature controller.

17. The gas sensor of claim 14, wherein the amines are selected from the group consisting of diethylamine, triethylamine, tert-butylamine, aniline, and pyridine.

18. The gas sensor of claim 14, wherein the sensitivity limit of said sensor is about 1.0 ppb.

19. The gas sensor of claim 14, wherein the detector is set to detect absorbance at a wavelength of 620 nm.

20. A method of monitoring an atmosphere for a gas analyte comprising:
providing a color neutral high surface area material;
dyeing said high surface area material with an indicator material capable of undergoing a reversible visible color change when exposed to said analyte;
placing a detector in line of sight with said high surface area material for detecting said color change; and
heating said high surface area material to desorb said analyte from said high surface area material after said detection to refresh said indicator material.
